(19) United States
(12) Patent Application Publication
(10) Pub. No.: US 2006/0269314 A1
(43) Pub. Date: Nov. 30, 2006

(54) Heat blocking apparatus for an image forming apparatus and image forming apparatus with the same

(75) Inventors: Sang-woon Lee, Seoul (KR); Heung-sup Jeong, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/325,315

(22) Filed: Jan. 5, 2006

(30) Foreign Application Priority Data
May 24, 2005 (KR) 10-2005-0043432

(51) Int. Cl. G03G 21/20

(52) U.S. Cl. 399/92

(57) ABSTRACT

An image forming apparatus includes a main body having an air inlet and an air outlet. A fixing unit is mounted in the main body and fuses an image onto a recording medium. A heat blocking member is disposed between the fixing unit and the main body to prevent heat generated by the fixing unit from being transmitted to the main body. A suction fan draws in external air to a space between the main body and the heat blocking member. A ventilation passage is provided to the heat blocking member to enable circulation of the external air drawn in by the suction fan and internal air overheated by the fixing unit. Accordingly, the temperature difference between the internal air heated by the fixing unit and the external air flowing between the fixing unit and the main body is reduced, thereby preventing generation of moisture at the heat blocking member.

### CROSS-REFERENCE TO RELATED APPLICATIONS

This application claims the benefit under 35 U.S.C. § 119(a) of Korean Patent Application No. 2005-43432, filed May 24, 2005, the entire contents of which are hereby incorporated by reference.

### BACKGROUND OF THE INVENTION

1. Field of the invention

The present invention relates to an image forming apparatus. More particularly, the present invention relates to an image forming apparatus that is capable of effectively blocking heat generated by a fixing unit.

2. Description of the Related Art

Image forming apparatuses such as copiers, printers, and facsimiles typically include an image carrying medium, which is usually a photoconductive drum. An electrostatic-latent-image formation unit forms an electrostatic latent image on the photoconductive drum, and a developing unit develops the electrostatic latent image formed on the photoconductive drum into a visible image by using developer. A transfer unit transfers the visible image formed on the photoconductive image onto an intermediate transfer belt or onto a printing medium, and a fixing unit permanently fuses the transferred image onto the printing medium by heat and pressure. With this type of structure, image formation processes (including formation of the electrostatic latent image, developing, transfer, and fusing) are repeatedly performed.

Recently, image forming apparatuses have been made smaller, which results in smaller spaces between the various components in the apparatus. Accordingly, heat generated by the fixing unit may affect other components. To address this problem, a structure capable of blocking the heat generated by the fixing unit has been suggested.

An example of such a fixing heat blocking structure is disclosed in Japanese Patent Publication No. 11-95644. FIG. 1 is a sectional view of the fixing heat blocking structure of the Japanese Patent Publication No. 11-95644, which is hereby incorporated by reference in its entirety.

Referring to FIG. 1, a ventilation duct 34 is provided between a fixing unit 18 and other image formation units such as a cleaning unit 15 in a main body (not shown) of the image forming apparatus. The ventilation duct 34 includes a plurality of holes 42. When a ventilation fan 39 is driven, the heat generated by the fixing unit 18 during fixing operations is drawn into the ventilation duct 34 through the holes 42 and then discharged outside the apparatus.

As can be appreciated from the above, the location of the fixing unit 18 is a significant consideration. In recent image forming apparatuses, the fixing unit 18 is generally disposed at an upper part of the main body, in the immediate vicinity of the main body.

FIG. 2 shows another example of a conventional fixing unit heat blocking structure, where the fixing unit 18 is disposed in the main body 10.

Referring to FIG. 2, the fixing unit 18 is disposed at an upper part of the inside of the main body 10. When the fixing unit 18 is proximate to the main body 10, the main body 10 may deform due to the fixing heat transmitted to the main body 10. When the fixing heat is transmitted to the main body 10, the heat may also make a user uncomfortable. To address this problem, a heat blocking member 30 is added between the main body 10 and the fixing unit 18, so that the heat generated by the fixing unit 18 cannot be directly transmitted to the main body 10.

Additionally, the heat blocking member 30 and the main body 10 form a space 40 which is used as an air passage to improve the heat blocking effect by streaming external air through the air passage.

When the air passage is provided as described above, however, moisture may be generated on the surface of the heat blocking member 30 due to a temperature difference between the fixing unit 18 and the external air. When the moisture forms water drops and the water drops fall into the fixing unit 18, the image formed on the recording medium P is damaged, thereby deteriorating image quality.

Furthermore, when the water drops fall and run into the component parts, moisture-sensitive parts may be damages.

Accordingly, there is a need for an improved apparatus for blocking heat in an image forming apparatus.

### SUMMARY OF THE INVENTION

An aspect of the present invention is to address at least the above described problems and/or disadvantages and to provide at least the advantages described below. Accordingly, an aspect of the present invention is to provide an image forming apparatus that does not generate water drops at a heat blocking member provided in the image forming apparatus.

In accordance with an exemplary embodiment of the present invention, an image forming apparatus includes a main body having an air inlet and an air outlet. A fixing unit is mounted in the main body and fuses an image onto a recording medium. A heat blocking member is disposed between the fixing unit and the main body to prevent heat generated by the fixing unit from being transmitted to the main body. A suction fan draws in external air to a space between the main body and the heat blocking member. A ventilation passage is provided in the heat blocking member to enable circulation of the external air drawn in by the suction fan and internal air which is heated by the fixing unit.

The ventilation passage may comprise a plurality of via-holes formed on the entire surface of the heat blocking member at predetermined intervals.

The suction fan may be mounted near the air inlet.

According to another exemplary embodiment of the present invention, an image forming apparatus includes a main body that has an air inlet and an air outlet. A fixing unit is disposed in the vicinity of an inner wall of an upper part of the main body and fuses an image onto a recording medium. A heat blocking member is disposed between the fixing unit and a top of the main body to block heat generated by the fixing unit. A suction fan draws in external air to a space between the main body and the heat blocking member. A ventilation passage is provided in the heat blocking member to enable circulation of the external air drawn in by the suction fan and internal air which is heated by the fixing unit.

The ventilation passage may comprise a plurality of via-holes formed on the surface of the heat blocking member at predetermined intervals.

The air inlet may be disposed at one side of an upper part of the main body, and the air outlet may be disposed at the opposite side, on a top of the main body.

The suction fan may be mounted near the air inlet.

The heat blocking member may include a ridge formed around the perimeter of the heat blocking member at a predetermined height and may additionally have a guide part for directing the air drawn in by the suction fan.

In an image forming apparatus having the above-described structure according to an exemplary embodiment of the present invention, generation of moisture on the heat blocking member can be effectively prevented by providing the heat blocking member with a ventilation passage for circulation of external air and heat generated by the fixing unit.

As a result, the image fixed on the recording medium is not affected by moisture, thereby also preventing deterioration of image quality.

### BRIEF DESCRIPTION OF THE DRAWING FIGURES

The above and other objects, features, and advantages of certain exemplary embodiments of the present invention will be more apparent from the following description taken in conjunction with the accompanying drawings, in which:

FIG. 1 shows a conventional fixing heat blocking structure;

FIG. 2 shows another conventional fixing heat blocking structure;

FIG. 3 is a schematic view of the overall structure of an image forming apparatus according to an exemplary embodiment of the present invention;

FIG. 4 is a partial, perspective view of a main body of the image forming apparatus according to an exemplary embodiment of the present invention;

FIG. 5 is a sectional view taken along the line V-V in FIG. 4; and

FIG. 6 is a partial, perspective view of a fixing heat blocking structure according to an exemplary embodiment of the present invention.

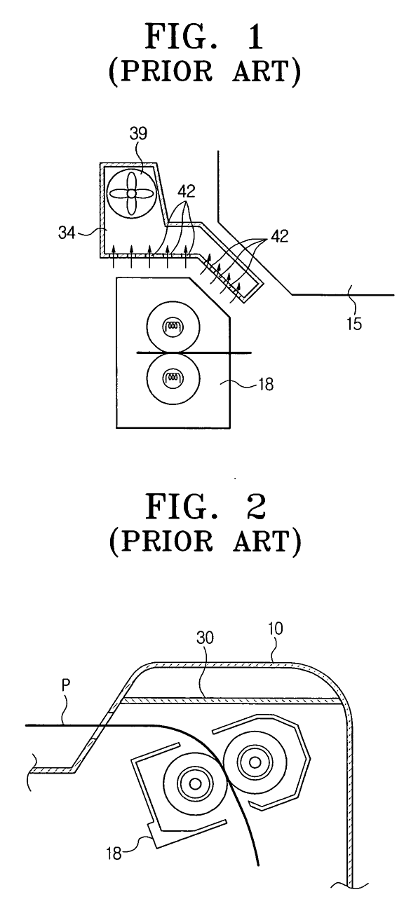

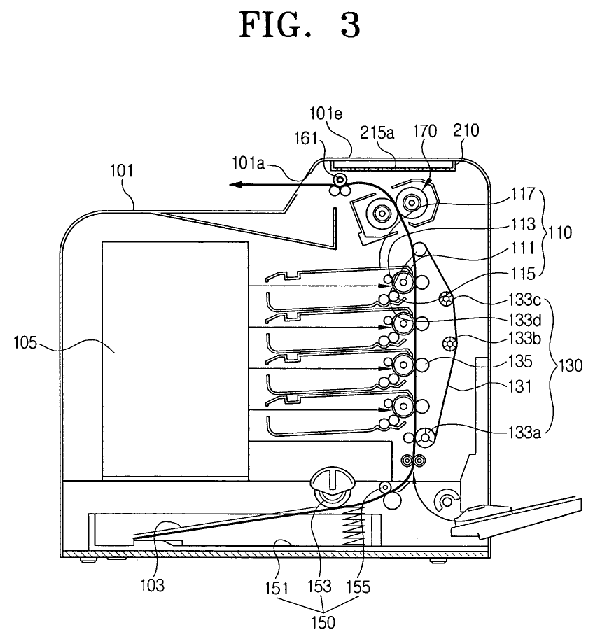

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the exemplary embodiments of the invention. Accordingly, those of ordinary skill in the art will recognize that various changes and modifications of the exemplary embodiments described herein can be made without departing from the scope and spirit of the invention. Also, descriptions of well-known functions and constructions are omitted for clarity and conciseness.

FIG. 3 is a longitudinal sectional view of an image forming apparatus that schematically shows the overall structure of the image forming apparatus, which performs image transfer by feeding a recording medium with a transfer belt.

Referring to FIG. 3, four image formation units 110 for four colors (such as black, cyan, magenta, and yellow) are mounted in a main body 101 of the apparatus. Each image formation unit 110 comprises a photoconductive medium 111, a charging roller 113, a developing roller 115, and a developer case 117.

A surface of the photoconductive medium 111 is electrically charged to a predetermined potential by the charging roller 113. As predetermined light such as a laser beam is projected by a laser scanning unit 105 onto the charged photoconductive medium 111, an electrostatic latent image is produced.

The electrostatic latent image formed on the photoconductive medium 111 is developed into a visible image through a developer supplied by the developing roller 115.

The transfer unit 130 comprises a belt 131 moving in contact with the photoconductive medium 111, a plurality of rollers 133a to 133d rotatably supporting the belt 131, and a plurality of transfer rollers 135 mounted inside the belt 131 to correspond to the photoconductive mediums 111.

When the electrostatic latent image on the photoconductive medium 111 is developed into a visible image by the developer supplied by the developing roller 115, the recording medium 103 is fed by the belt 131. A color image is formed by overlapping the visible images formed by the four image formation units 110 on the recording medium 103.

A paper feeding unit 150 supplies the recording medium 103 to a space between the belt 131 and the transfer roller 135. To do this, the paper feeding unit 150 comprises a paper cassette 151 where a plurality of a recording medium 103 is stacked, a pickup roller 153 to pick up the recording medium 103 stacked on the paper cassette 151, and a feeding roller 155 to convey the picked-up recording medium 103.

A fixing unit 170 fuses the color image onto the recording medium 103 by applying heat and pressure to the recording medium passed between the belt 131 and the transfer rollers 135. The fixing unit 170 comprises a heating roller 171 and a pressing roller 173.

The recording medium 103 on which the color image is fused is conveyed by a discharge roller 161 and discharged to the outside of the main body 101 through a discharge port 101a.

A heat blocking structure for preventing heat generated by the fixing unit 170 from being transmitted to the main body 101 and a structure for preventing generation of moisture at the heat blocking structure will now be described in greater detail.

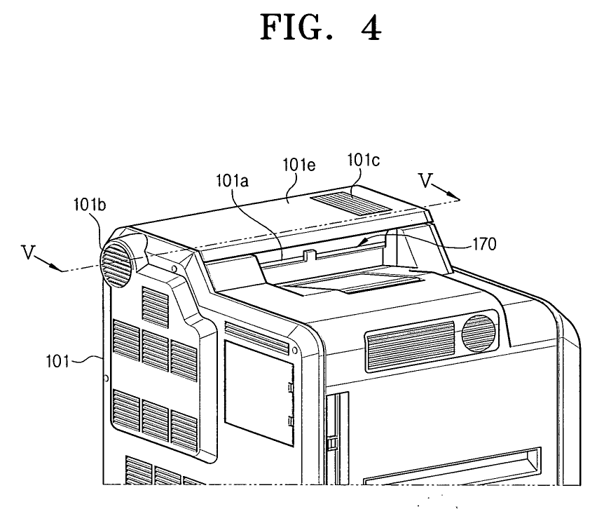

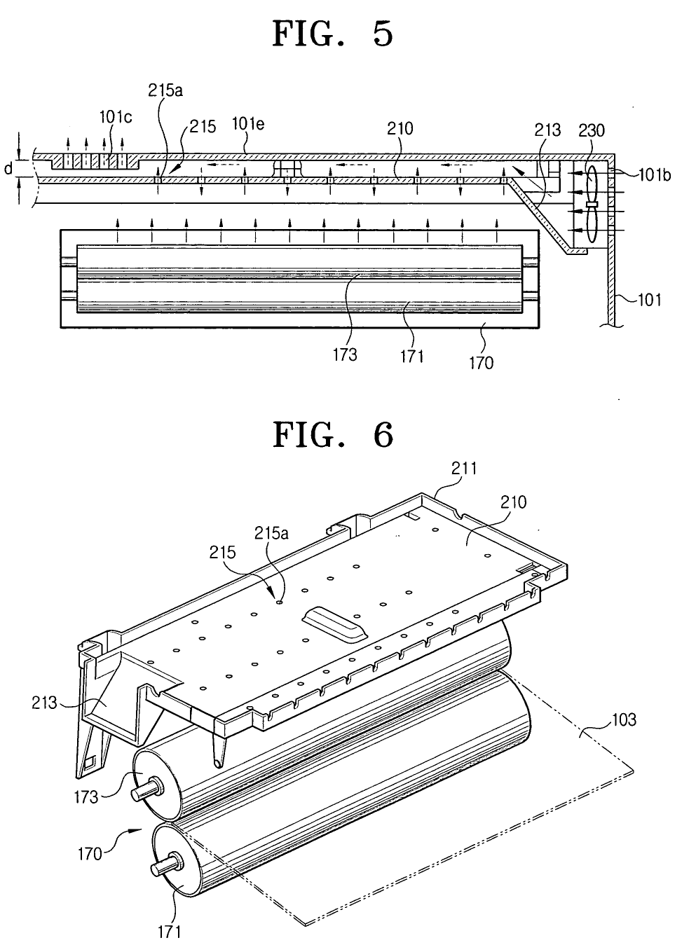

FIG. 4 is a partial, perspective view showing an exterior structure of the main body 101 of the image forming apparatus. FIG. 5 is a sectional view taken along the line V-V in FIG. 4. FIG. 6 is a partial, perspective view showing the heat blocking structure according to an exemplary embodiment of the present invention.

Referring to FIG. 4, an air inlet 101b is formed at one side of an upper part of the main body 101. External air can flow into the main body 101 through the air inlet 101b. An air outlet 101c is formed at the opposite side of the main body 101. Preferably, the air outlet is formed on a top 101e of the main body 101.

Referring to FIGS. 5 and 6, a heat blocking member 210 is disposed between the top 101e of the main body 101 and the fixing unit 170. The heat blocking member 210 comprises a ridge 211 formed around the perimeter of the heat blocking member 210 at a predetermined height, or distance, ‘d’ from the top 101e of the main body 101.

The main body 101 includes a suction fan 230 for forcibly drawing in external air through the air inlet 101b The heat blocking member 210 is provided with a guide part 213 for directing the external air drawn in by the suction fan 230 to flow between the top 101e of the main body 101 and the heat blocking member 210. Additionally, a ventilation passage 215 is formed in the heat blocking member 210. The ventilation passage 215 comprises a plurality of via-holes 215 a formed at predetermined intervals on, preferably, the entire surface of the heat blocking member 210.

According to the above structure, the heat generated by the fixing unit 170 can be blocked from the main body 101 due to the air layer flowing between the top 101e of the main body 101 and the heat blocking member 210. As a result, the main body 101 will not be deformed by the fixing heat and also, the user does not have to feel uncomfortable due to heat transmitted to the main body 101.

A part of the external air flowing between the top 101e and the heat blocking member 210 descends toward the fixing unit 170 through the via-holes 215a formed on the heat blocking member 210 while the heat generated by the fixing unit 170 ascends through the via-holes 215a, thereby causing air circulation. The air circulation relieves the temperature difference between the heat blocking member 210 and the fixing unit 170, so that moisture is not generated on a surface of the heat blocking member 210.

Although the heat blocking member 210 is disposed at the upper part of the fixing unit 170 in this exemplary embodiment, the location of the heat blocking member 210 is not limited according to the present invention, as long as the heat blocking member 210 is able to block the heat of the fixing unit 170 in the vicinity of the main body 101.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. An image forming apparatus comprising:
a main body having an air inlet and an air outlet;
a fixing unit mounted in the main body, the fixing unit fusing an image onto a recording medium;
a heat blocking member disposed between the fixing unit and the main body to prevent heat generated by the fixing unit from being transmitted to the main body;
a suction fan drawing in external air to a space between the main body and the heat blocking member; and
a ventilation passage provided to the heat blocking member to enable circulation of the external air drawn in by the suction fan and internal air heated by the fixing unit.

2. The image forming apparatus of claim 1, wherein
the ventilation passage comprises a plurality of via-holes formed on the entire surface of the heat blocking member at predetermined intervals.

3. The image forming apparatus of claim 1, wherein
the suction fan is mounted near the air inlet.

4. The image forming apparatus of claim 1, wherein
the suction fan draws in the external air through the air inlet in the main body.

5. The image forming apparatus of claim 1, wherein
the suction fan exhausts the external air through the air outlet in the main body.

6. The image forming apparatus of claim 1, wherein
the heat blocking member includes a ridge formed around the perimeter of the heat blocking member.

7. The image forming apparatus of claim 6, wherein
the heat blocking member has a guide part for directing the air drawn in by the suction fan

8. The image forming apparatus of claim 1, wherein
the main body has an upper wall, and the fixing unit is located proximate to the upper wall.

9. An image forming apparatus comprising:
a main body having an air inlet and an air outlet;
a fixing unit disposed in the vicinity of an inner wall of an upper part of the main body, the fixing unit fusing an image onto a recording medium;
a heat blocking member disposed between the fixing unit and a top of the main body to block heat generated by the fixing unit;
a suction fan drawing in external air to a space between the main body and the heat blocking member; and
a ventilation passage provided to the heat blocking member to enable circulation of the external air drawn in by the suction fan and internal air overheated by the fixing unit.

10. The image forming apparatus of claim 9, wherein
the ventilation passage comprises a plurality of via-holes formed on the entire surface of the heat blocking member at predetermined intervals.

11. The image forming apparatus of claim 9, wherein
the air inlet is disposed at one side of an upper part of the main body, and the air outlet is disposed at the opposite side, on a top of the main body.

12. The image forming apparatus of claim 11, wherein
the suction fan is mounted near the air inlet.

13. The image forming apparatus of claim 12, wherein
the suction fan draws in the external air through the air inlet in the main body.

14. The image forming apparatus of claim 13, wherein
the suction fan exhausts the external air through the air outlet in the main body.

15. The image forming apparatus of claim 12, wherein
the heat blocking member includes a ridge formed around the perimeter of the heat blocking member at a predetermined height.

16. The image forming apparatus of claim 15, wherein
the heat blocking member has a guide part for directing the air drawn in by the suction fan.
